(19) United States
(12) Patent Application Publication
(10) Pub. No.: US 2004/0020544 A1
(43) Pub. Date: Feb. 5, 2004

(54) Pressure bag and method of lining branch pipe

(76) Inventors: Takao Kamiyama, Hiratsuka-shi (JP); Yasuhiro Yokoshima, Ibaraki-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/406,823

(22) Filed: Apr. 3, 2003

(30) Foreign Application Priority Data
Apr. 5, 2002 (JP) 2002-103508
Apr. 19, 2002 (JP) 2002-117122

(51) Int. Cl. F16L 55/16

(52) U.S. Cl. 138/98; 405/150.1

(57) ABSTRACT

A pressure bag is used to line a branch pipe, wherein a heat medium hose can be securely pulled with an everting force of a branch pipe liner bag to stably line the branch pipe. The pressure bag has one end closed by an end collar for containing the branch pipe liner bag. The end collar is formed with a hot water supply port and a hot water discharge port, as well as a sealing member for slidably supporting a pull rope or a belt extending therethrough in an air-tight seal. A hot water supply pipe in communication with the hot water supply port is disposed within the end collar, and a flexible hot water hose is attached to the hot water supply pipe. The hot water hose is folded and contained in the pressure bag. A head collar comprising a head collar push-up lever is attached to the end of the pressure bag opposite to the end to which the end collar is attached.

### PRIORITY INFORMATION

This application is based on and claims priority to Japanese Patent Applications Nos. 2002-103508 (filed on Apr. 5, 2002) and 2002-117122 (filed on Apr. 19, 2002), entire contents of which are hereby expressly incorporated by reference herein.

### BACKGROUND OF THE INVENTION

1. Field of the Invention

The present invention relates generally to branch pipe lining techniques and, more particularly, to a pressure bag for use in lining a branch pipe and to a method of lining a branch pipe. 2. Description of the Related Art

When an underground pipe, such as pipelines and passageways, becomes defective or too old to perform properly, the pipe is repaired and rehabilitated without digging the earth to expose the pipe and disassembling the sections of the pipe. This non-digging method of repairing an underground pipe has been known and practiced commonly in the field of civil engineering. The pipe lining method utilizes a tubular pipe liner bag made of a resin-absorbent material impregnated with a hardenable resin, and having the outer surface covered with a highly air-tight plastic film. The tubular pipe liner bag is inserted into a pipe to be repaired by means of a pressurized fluid such that the pipe liner bag is turned inside out as it proceeds deeper in the pipe. Hereinafter, this manner of insertion shall be called “everting.” When the entire length of the tubular liner bag is everted (i.e., turned inside out) into the pipe, the everted tubular liner is pressed against the inner wall of the pipe by a pressurized fluid, and the tubular flexible liner is hardened as the hardenable resin impregnated in the liner is heated, which is effected by heating the fluid filling the tubular liner bag. It is thus possible to line the inner wall of the defective or old pipe with a rigid liner without digging the ground and disassembling the pipe sections. The foregoing pipe lining method can be similarly applied to the lining of a main pipe of sewerage pipes or the like and a branch pipe branched off the main pipe.

For lining a branch pipe, a branch pipe lining method typically employs a branch pipe liner bag made of a resin-absorbent material impregnated with a hardenable resin, and having the outer surface covered with a highly air-tight plastic film. The branch pipe liner bag is introduced into a main pipe, and a flange formed at one end of the branch pipe liner bag is brought into close contact with the peripheral edge of a branch pipe opening of the main pipe. Then, the branch pipe liner bag is everted into a branch pipe to be repaired from the main pipe toward the ground by a fluid pressure. With the branch pipe liner bag maintained in close contact with the inner wall of the branch pipe, the hardenable resin impregnated in the branch pipe liner bag is hardened to line the inner wall of the branch pipe.

However, depending on situations on the ground, a branch pipe cannot be lined over the entire length thereof, in which case the branch pipe cannot but be partially lined only for a predetermined length from a main pipe.

### SUMMARY OF THE INVENTION

An aspect of the present invention involves a pressure bag for partially lining a pipe (e.g., a branch pipe) and a method of lining the branch pipe using the pressure bag to line a greater portion of the pipe than prior systems. To understand this aspect of the invention further, generally reference will now be made to a specific preferred embodiment, which is illustrated in FIG. 14. This embodiment will be described in greater detail below in connection with the detailed descriptions of illustrated preferred embodiments.

The branch pipe liner bag 101 comprises a tubular resin-adsorbent material 102 formed with a flange 103 at one end, and a tear-off end 107 attached to the other end of the tubular resin-adsorbent material 102. The tear-off end 107 can be torn off from the tubular resin-adsorbent material 102. The flange 103 of the branch pipe liner bag 101 is pressed by a work robot 135 into close contact with the peripheral edge of a branch pipe opening of a main pipe 130 (a portion of the main pipe 130 open to a branch pipe 131), as illustrated.

Next, compressed air is introduced into a closed space S in a pressure bag 111 through an air hose 147 by a compressor (not shown). The liner bag 101 is inserted, while everting, upwardly toward the ground within the branch pipe 131 from the main pipe 130 by the pressure of the compressed air.

After the branch liner bag 101 has been inserted and everted into the branch pipe 131 as shown in FIG. 15, the tubular resin-absorbent material 102 of the branch liner bag 101 is pressed onto an inner wall of a portion of the branch liner bag 131 that extends from the main pipe 130. In this state, a hot water pump, not shown, is driven to supply hot water into the closed space S through a hot water hose 109 to heat the branch pipe liner bag 101, as pressed on the inner wall of the branch pipe 131, and to harden the thermosetting resin impregnated in the tubular resin-adsorbent material 102 by the hot water.

Subsequently, the hot water is removed from the closed space S. Then, as illustrated in FIG. 16, a head 136 of the work robot 135 is moved downward to tear off a head collar 116 from the flange 103 of the branch pipe liner bag 101, and the hot water hose 109 is pulled in a direction indicated by an arrow in FIG. 16 (to the left in FIG. 16) to tear off the tear-off end 107 from the tubular resin-adsorbent material 102, with the result that the hardened tubular resin-adsorbent material 102 remains in the branch pipe 131, thereby partially lining and the inner wall of the branch pipe 131 with the tubular resin-adsorbent material 102 to repair the branch pipe 131.

The branch pipe lining method described above, however, implies a problem which may arise when there is a long distance between a manhole and the branch pipe liner bag 101, where the heavier and longer hot water hose 109, required by the distance, cannot pull with an everting force of the branch pipe liner bag 101, generated by the air pressure.

In addition, a high tension is required for tearing off the tear-of end 107 after lining, so that the hot water hose 109, which pulls the tear-off end 107, must have a high resistance to tension, resulting in the use of a much heavier hot water hose. As a result, it becomes difficult to pull the hot water hose 109 with the everting force of the branch pipe liner bag 101.

This aspect of the present invention has been made in view of the problem mentioned above, and it is an object of this aspect of the present invention to provide a pressure bag which can securely pull a heat medium hose with an everting force of a branch pipe liner bag, irrespective of the length of the heat medium hose, to stably perform a lining operation required for a branch pipe without fail.

To achieve some or all of the above objects, in accordance with this aspect of the present invention, a pressure bag is provided for use in lining a branch pipe with a branch pipe liner bag. The pressure bag includes an end collar which closes one end of the pressure bag for containing the branch pipe liner bag, a heat medium supply port and a heat medium discharge port formed through the end collar, and a sealing member for slidably supporting a pull rope or a belt extending therethrough in an air-tight state.

Preferably, the pressure bag further includes a head collar including a head collar push-up lever movable associated with a fluid pressure acting on the pressure bag, the head collar attached to the end of the pressure bag opposite to the end to which the end collar is attached.

Another aspect of the present invention provides a method of lining a branch pipe using a branch pipe liner bag having a tubular resin-absorbent material having a flange formed at one end thereof, having the outer surface covered with a highly air-tight film, and impregnated with an unhardened hardenable resin, and a tear-off end attached to the other end of the tubular resin-adsorbent material. The method includes the steps of introducing the branch pipe liner bag contained in a pressure bag except for the flange into a main pipe, wherein the pressure bag includes an end collar which closes one end of the pressure bag for containing the branch pipe liner bag, a heat medium supply port and a heat medium discharge port formed through the end collar, and a sealing member for slidably supporting a pull rope or a belt extending therethrough in an air-tight state, placing the flange of the branch pipe liner bag in close contact with a peripheral edge of a branch pipe opening of the main pipe, supplying a pressure fluid into the pressure bag to evert the branch pipe liner bag into the branch pipe from the main pipe to the ground by the action of a fluid pressure, pulling a heat medium hose into a closed space defined by the pressure bag and the branch pipe liner bag, supplying a heat medium from the heat medium hose into the closed space to heat the branch pipe liner bag with the heat medium, hardening the thermosetting resin impregnated in the branch pipe liner bag, and pulling the pull rope or belt to tear off the tear-off end for removal from the branch pipe.

Preferably, the method further includes the steps of lining the main pipe using a main pipe liner bag, cutting a portion of the main pipe liner bag corresponding to the branch pipe opening, and scraping off a coating plastic film of the main pipe liner bag around the peripheral edge of the branch pipe opening with a wire brush before lining the branch pipe.

Also, preferably, in the method of lining a branch pipe, the pressure bag further includes a head collar including a head collar push-up lever, where the head collar is attached to the end of the pressure bag opposite to the end to which the end collar is attached. The method further includes the step of applying the fluid pressure acting in the pressure bag to the head collar push-up lever to push up the head collar to press the flange of the branch pipe liner bag onto the peripheral edge of the branch pipe opening of the main pipe liner bag.

According to the method of lining a branch pipe using the pressure bag, the pull rope is pulled to tear off the tear-off end for removal from the branch pipe liner bag after the branch pipe liner bag has been hardened, so that no tension acts on the heat medium hose. Consequently, a light-weighted heat medium hose can be used. Therefore, irrespective of the length of the heat medium hose, the heat medium hose can be pulled with a force produced by everting the branch pipe liner bag and placed inside of the branch pipe liner bag without fail. It is therefore possible to stably line the branch pipe as required without fail.

In addition, since the pressure bag is inflated by the action of the pressure of a fluid pressure to push up the head collar push-up lever, the entire head collar is pushed up to uniformly press the flange of the branch pipe liner bag onto the peripheral edge of the branch pipe opening, thereby bringing the flange into close contact with the peripheral edge of the branch pipe opening.

In accordance with a further aspect of the present invention, a lining device is provided for use in a pipe lining. The lining device comprises a tubular member having first and second end portions. A pipe liner bag can be enclosed within the tubular member. One end of the pipe liner bag can be placed at an opening of the pipe through the first end portion. A removal member is attached at another end of the pipe liner bag. A pulling member is affixed to the removal member. The second end portion defines first and second ports. First port allows a fluid to be drawn into the tubular member to pressurize the pipe liner bag. The second port allows the pulling member to extend out of the tubular member. A heat medium supplying member extends into the tubular member. An end of the heat medium supplying member is affixed to the removal member. The pipe liner bag can extend into a pipe with carrying the pulling member and the heat medium supplying member by the removal member. The removal member is separable from the pipe liner bag with the heat medium supplying member when the pulling member is pulled.

In accordance with an additional aspect of the present invention, a method of lining a pipe comprises enclosing a pipe liner bag in a tubular member having first and second end portions, placing one end of the pipe liner bag at an opening of the pipe through the first end portion, attaching a removal member at another end of the pipe liner bag, affixing a pulling member to the removal member, extending the pulling member out of the tubular member through the second end portion, affixing a heat medium supplying member to the removal member, extending the heat medium supplying member out of the tubular member through the second end portion, supplying a pressurized fluid into the tubular member such that the pipe liner bag extends into the pipe with carrying the pulling member and the heat medium supplying member by the removal member, supplying a heat medium toward the pipe liner bag through the heat medium supplying member to heat the pipe liner bag, and pulling the pulling member to remove the removal member with the heat medium supplying member from the pipe liner bag.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein. Additionally, the above and other objects, features, and advantages of the present invention will become further apparent from the following detailed description of the preferred embodiments thereof when read in conjunction with the accompanying drawings.

### BRIEF DESCRIPTION OF THE DRAWINGS

FIG. 1 is a cross-sectional view of a branch pipe liner bag for use in lining a branch pipe;

FIG. 2 is a vertical sectional view of a pressure bag according to one embodiment of the present invention;

FIG. 3 is an enlarged view illustrating in detail an end collar portion of the pressure bag according to one embodiment of the present invention;

FIG. 4 is a cross-sectional view taken along a line A-A in FIG. 3;

FIG. 5 is an enlarged view of a portion B in FIG. 3 in greater detail;

FIGS. 6 to 8 are cross-sectional views illustrating a method of lining a main pipe;

FIGS. 9 to 13 are cross-sectional views illustrating a method of lining a branch pipe according to one embodiment of the present invention; and

FIGS. 14 to 16 are cross-sectional views illustrating an exemplary method of lining a branch pipe.

### DESCRIPTION OF THE PREFERRED EMBODIMENTS

The present invention will hereinafter be described in connection with several preferred embodiments thereof with reference to the accompanying drawings.

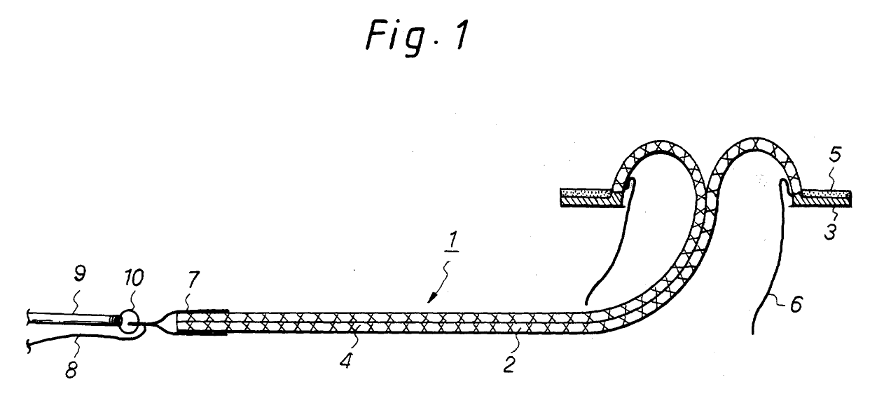

FIG. 1 is a cross-sectional view of a branch pipe liner bag 1 for use in a method of lining a branch pipe according to one embodiment of the present invention. The illustrated branch pipe liner bag 1 comprises a tubular resin-adsorbent material 2 made of unwoven fabric, one end of which is folded out to form a flange 3. An unhardened liquid thermosetting resin is impregnated in a portion of the tubular resin-adsorbent material 2 except for the flange 3, and a highly air-tight plastic film 4 is covered over the outer surface of that portion.

A material for the unwoven fabric constituting the tubular resin-absorbent material 2 may be selected from polyester, polypropylene, acrylic fabric, vinylon and so on. For the thermosetting resin impregnated into the tubular resin-absorbent material 2, unsaturated polyester resin, epoxy resin or the like may be used. Also, as a material for the plastic film 4, polyurethane, polyethylene, polyethylene/nylon copolymer, vinyl chloride or the like may be selected.

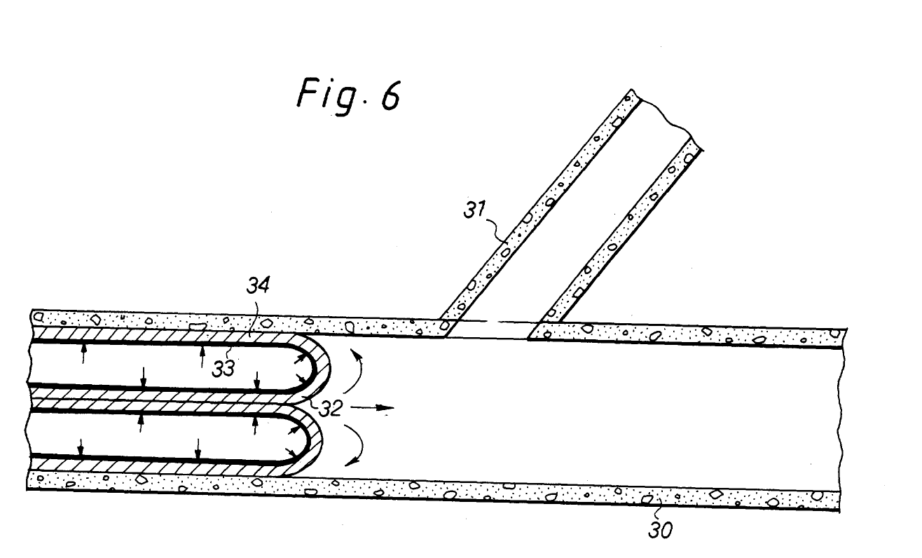

It should be noted that the flange 3 formed at one end of the tubular resin-adsorbent material 2 has an arcuate surface with a curvature equal to the curvature of the inner wall of a main pipe 30 (see FIG. 6), later described, and its outer diameter is set larger than the inner diameter of a branch pipe 31 (see FIG. 6), later described. Then, the flange 3 maintains its shape by the hardened hardenable resin impregnated in the tubular resin-adsorbent material 2. Further, an adhesive impregnated resin-adsorbent material 5 is attached on the surface of the flange 3. Here, the adhesive impregnated resin-adsorbent material 5 is made of a felt material which is impregnated with an adhesive such as an epoxy resin.

One end of a tear-off valve 6 is attached on the outer periphery of the branch pipe liner bag 1 near the flange 3 in such a manner that the tear-off valve 6 can be torn off from the branch pipe liner bag 1.

A tubular tear-off end or removal member 7 is also attached to the other end (everted end) of the tubular resin-adsorbent material 2 in such a manner that the tubular tear-off end 7 can be torn off from the tubular resin-adsorbent material 2. The tear-off end 7 has one closed end, and the other open end which is fitted on the outer periphery of the end of the tubular resin-adsorbent material 2. The edge of the opening of the tear-off end 7 is attached to the plastic film 4 covered over the outer surface of the tubular resin-adsorbent material 2 in such a manner that they can be torn off from each other. A pull rope 8 is attached to the tear-off end 7, and a hot water hose 9 is attached through a rubber rope 10.

The pull rope 8 used herein may be made of a steel or stainless steel wire having a diameter of 3 mm to 8 mm, coated with PVC, polyurethane, nylon, or the like. Alternatively, a pull belt made of unwoven fabric coated with PCV, polyurethane, nylon, or the like may be used instead of the pull rope 8. The hot water hose 9, which may be made of PCV and woven fabric, maintains a flat shape in a non-pressure state. The rubber rope 10 is made of a mixture of rubber and woven fabric.

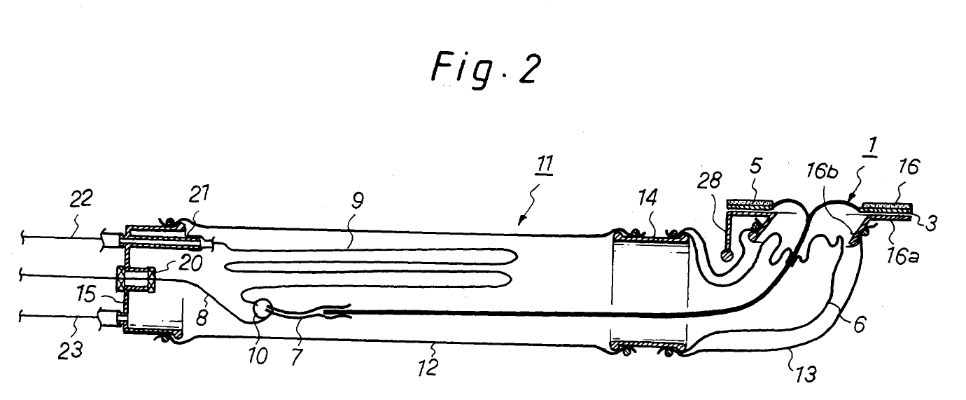

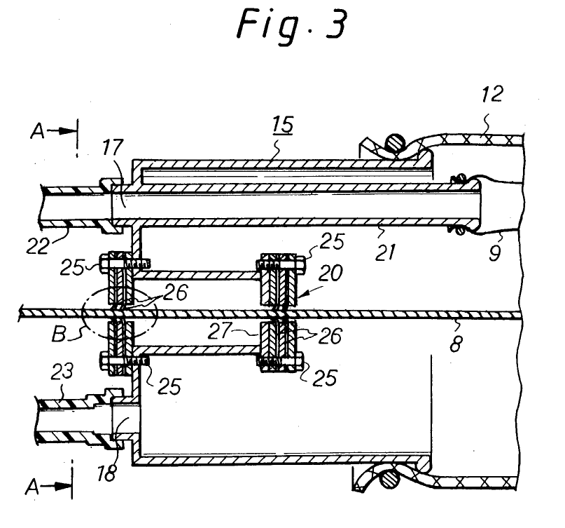

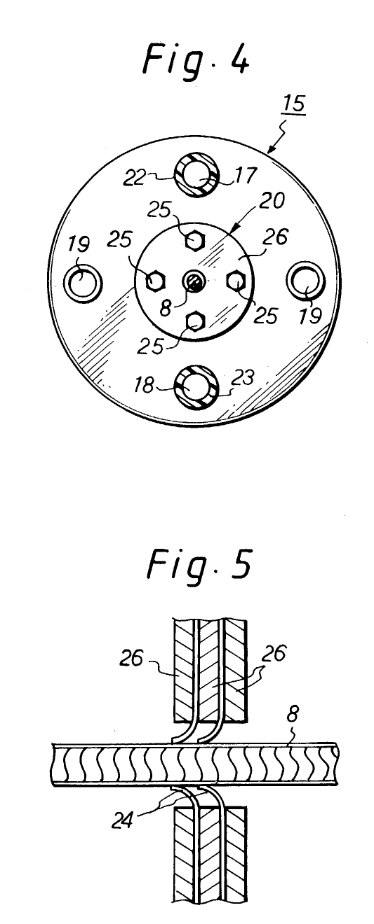

Next, the structure of a pressure bag according to one embodiment of the present invention will be described in detail with reference to FIGS. 2 to 5. FIG. 2 is a vertical sectional view of the pressure bag; FIG. 3 is an enlarged view of an end collar portion of the pressure bag shown in greater detail; FIG. 4 is a cross-sectional view taken along a line A-A in FIG. 3; and FIG. 5 is an enlarged view of a portion B in FIG. 3 shown in greater detail.

As illustrated in FIG. 2, the pressure bag or lining device 11 according to one embodiment of the present invention comprises a flexible tubular bag 12; an elbow bag 13 angled at 45°; an intermediate collar 14 which connects the tubular bag 12 with the elbow bag 13; an end collar 15 which closes one end of the tubular bag 12; and a head collar 16 attached to the elbow bag 13. The pressure bag 11 contains the branch pipe liner bag 1 except for the flange 3, the pull rope 8, and the hot water hose 9.

The tubular bag 12 and elbow bag 13 herein used may be made of tubular unwoven fabric or woven fabric, the inner surface of which is covered with a plastic film. The end collar 15 and head collar 16 may be made of metal such as steel, stainless steel, aluminum, or the like.

As illustrated in FIGS. 3 and 4, the end collar 15 is formed with a hot water supply port 17 and a hot water discharge port 18 as well as with an air hose attachment port 19 (see FIG. 4). A sealing construction 20 is formed in a central portion of the end collar 15.

The end collar 15 is also formed with hot water supply pipe 21 in communication with the hot water supply port 17. As illustrated in FIG. 3, the hot water supply pipe 21 protrudes horizontally toward the inside of the end collar 15. One end of the hot water hose 9 is attached to the open end of the hot water supply pipe 21. Here, as illustrated in FIG. 2, the hot water hose 9 is folded and contained in the pressure bag 11. Alternatively, the hot water hose 9, as contained in the pressure bag 11, may be wound up.

Then, as illustrated in FIGS. 3 and 4, the hot water supply port 17 and hot water discharge port 18 formed through the end collar 15 are connected to hot water hoses 22, 23, disposed outside the pressure bag 11, respectively.

As illustrated in FIG. 3, the sealing construction 20 slidably passes the pull rope 8 therethrough in an air-tight structure. The illustrated sealing construction comprises first and second sealing sections spaced apart from each other. The first section is formed at an outer surface of the end collar 15. The second section is formed internally of the end collar 15 more than the first section. The pull rope 8, one end of which is attached to the tear-off end 7 of the branch pipe liner bag 1, extends to the outside of the pressure bag 11 through the first and second sections of the sealing construction 20.

As illustrated in FIG. 3, the sealing construction 20 comprises a plurality (two in the illustrated example) of sealing members or packings 24 (see FIG. 5) each group disposed at the first and second sections. The sealing members 24 disposed at the first section is sandwiched by a plurality (three in the illustrated example) of nylon plates 26 attached on the outer surface of the end collar 15 with a plurality (four in the illustrated example) of bolts 25. Similarly, the sealing members 24 disposed at the second section is sandwiched by a plurality (three in the illustrated example) nylon plates 26 attached on the inner end surface of a cylindrical member 27 with a plurality of bolts 25. Each sealing member 24 defines an opening. An inner diameter of the opening is slightly smaller than an outer diameter of the pull rope 8. Thus, respective inner peripheral ends of the sealing members 24 abut the outer periphery of the pull rope 8 and deformed. The sealing members 24 may be made of polyurethane, fluoric rubber, or the like.

As illustrated in FIG. 2, the head collar 16 comprises an annular flange 16a; and a cylindrical member 16 obliquely attached below the flange 16a. A head collar push-up lever 28 protrudes downward from the outer periphery of the flange 16a. Then, the open end of the elbow bag 13 is attached to the outer periphery of the cylindrical member 16b of the head collar 16.

As illustrated in FIG. 2, the branch pipe liner bag 1, when it is set, has the flange 3 carried on the top surface of the flange 16a of the head collar 16, and the remaining portion except for the flange 3 contained in the pressure bag 11 as illustrated.

The method of lining a branch pipe according to one embodiment of the present invention is performed using the branch pipe liner bag 1, and the pressure bag 11 which contains the branch pipe liner bag 1. Prior to the method of lining a branch pipe, the main pipe is lined. Therefore, a method of lining the main pipe will be first described in brief. FIGS. 6 to 8 are cross-sectional views illustrating in order several steps involved in the method of lining the main pipe.

In FIGS. 6 to 8, the main pipe 30 may be a main pipe of a sewerage line, and the branch pipe 31 of a smaller diameter is confluent to the main pipe 30. For lining the main pipe 30, a main pipe lining bag 32 is everted into the main pipe 30 by the action of fluid pressure. The main pipe liner bag 32 comprises a tubular resin-adsorbent material 34; a highly air-tight plastic film 33 coated over the outer surface of the tubular resin-adsorbent material 34; and an unhardened liquid thermosetting resin impregnated in the tubular resin-adsorbent material 34. The plastic film 33, tubular resin-adsorbent material 34, and thermosetting resin may be similar to those used for the branch pipe liner bag 1.

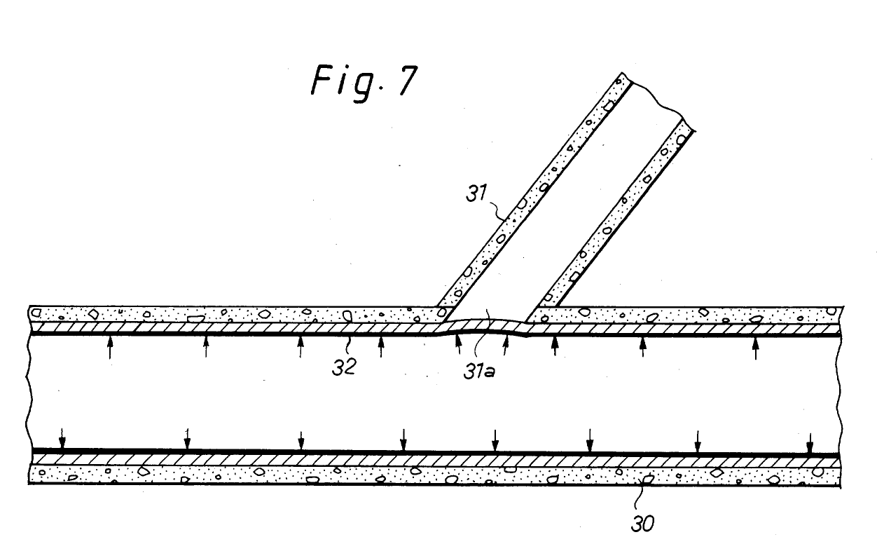

As the main pipe liner bag 32 has been everted into the main pipe 30 over its whole length, the main pipe liner bag 32 is inflated by a fluid pressure, as illustrated in FIG. 7, to press the main pipe liner bag 32 onto the inner wall of the main pipe 30. In this state, the main pipe liner bag 32 is heated by an arbitrary means. This heating hardens the thermosetting resin impregnated in the main pipe liner bag 32, so that the inner wall surface of the main pipe 30 is lined by the hardened main pipe liner bag 32 and thus repaired.

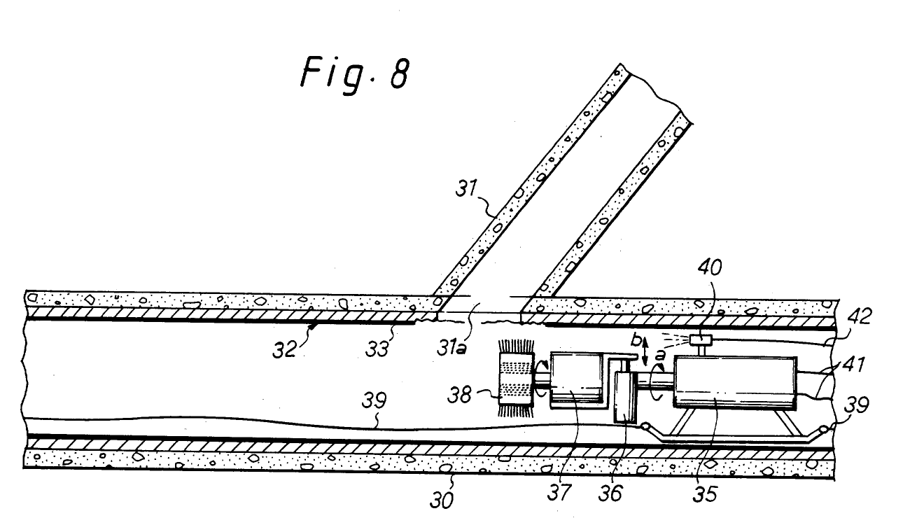

As the main pipe 30 has been lined in the foregoing manner, a branch pipe opening (a portion of the main pipe 30 open to a branch pipe 31) is closed by the main pipe liner bag 32, so that a portion of the main pipe liner bag 32 which closes the branch pipe opening 31a is cut away in a cutting operation using a cutter, not shown. As a result, the branch pipe 31 communicates with the main pipe 30 through the branch pipe opening 31a, as illustrated in FIG. 8. Subsequently, the plastic film 33 around the peripheral edge of the branch pipe opening 31a of the main pipe liner bag 32 is scraped off in the following manner.

As illustrated in FIG. 8, an in-pipe work robot 35 is introduced into the main pipe 30. The robot 35 is provided with a head 36 which is mounted at a leading end and is hydraulically rotatable in a direction indicated by an arrow a in FIG. 8 and vertically movable in a direction indicated by an arrow b. A hydraulic motor 37 is fixed to the head 36, and a wire brush 38 is attached to an output shaft of the hydraulic motor 37. The wire brush 38 may be made of a material selected from steel, brass, stainless steel, and the like.

Then, the in-pipe work robot 35 is moved within the main pipe 30 by a pull rope 39 connected to the in-pipe work robot 35 and positioned near the branch pipe opening 31a, as illustrated. As a TV camera 40 installed on the robot 35 is used to monitor near the branch pipe opening 31a within the main pipe 30 on the ground, the hydraulic motor 37 is driven to rotate the wire brush 38, and rotate the head 36 in the direction indicted by the arrow a as well as vertically move the head 36 in the direction indicated by the arrow b to scrape off the plastic film 33 around the peripheral edge of the branch pipe opening 31a of the main pipe liner bag 32 by the wire brush 38. In FIG. 8, a hydraulic hose 41 and a TV cable 42 are also used in the operation.

As the plastic film 33 is scraped off from the peripheral edge of the branch pipe opening 31a of the main pipe liner bag 32 after the main pipe 30 has been lined in the foregoing manner, the branch pipe 31 is lined in the following procedure.

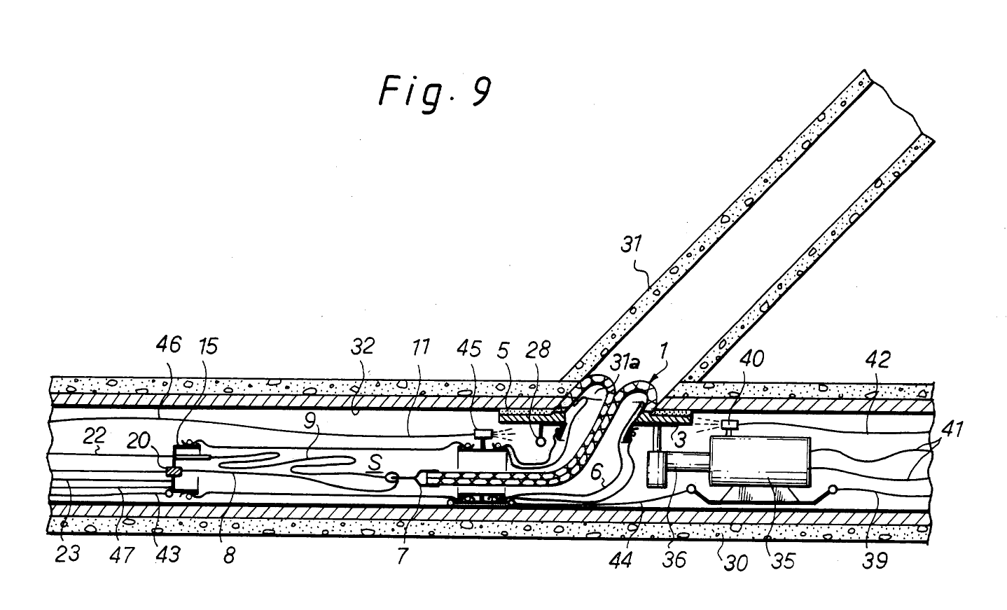

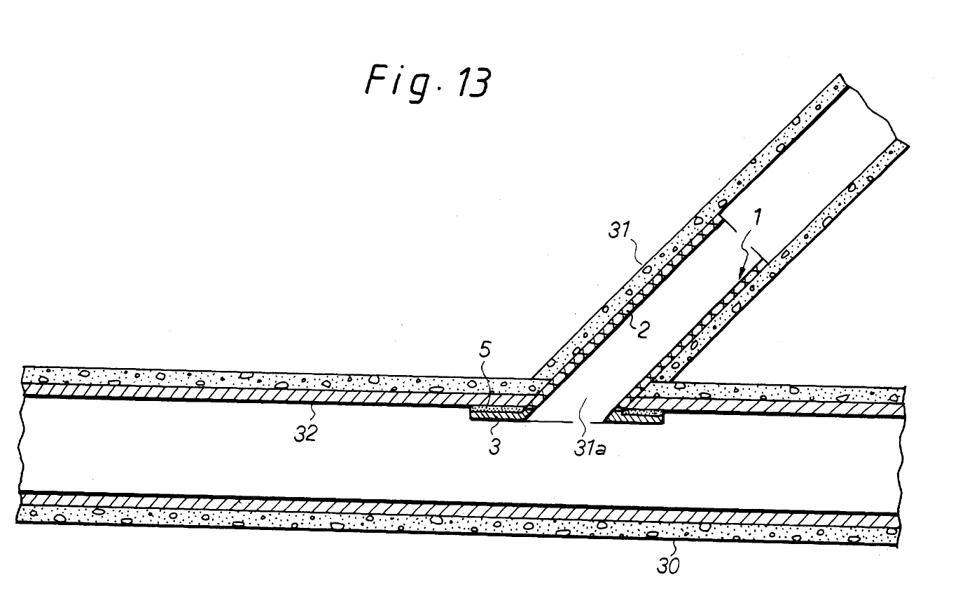

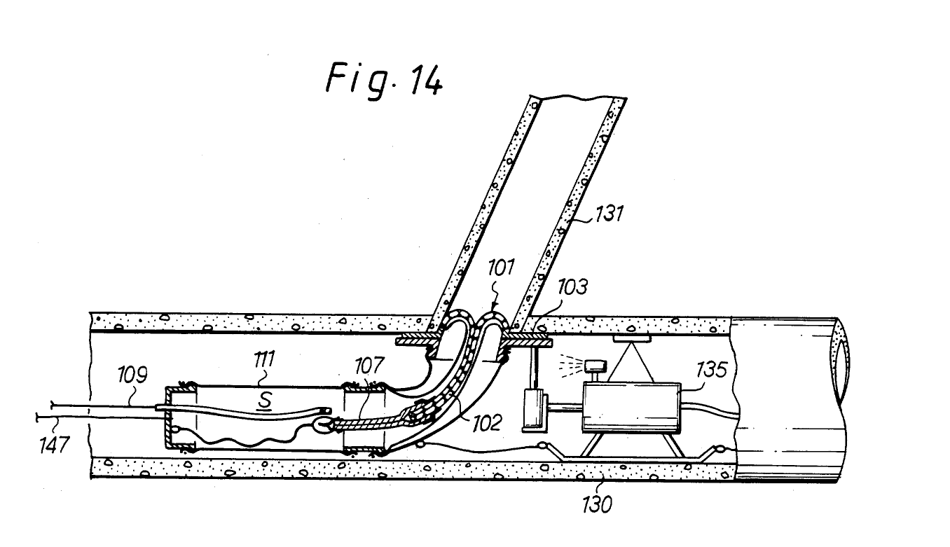

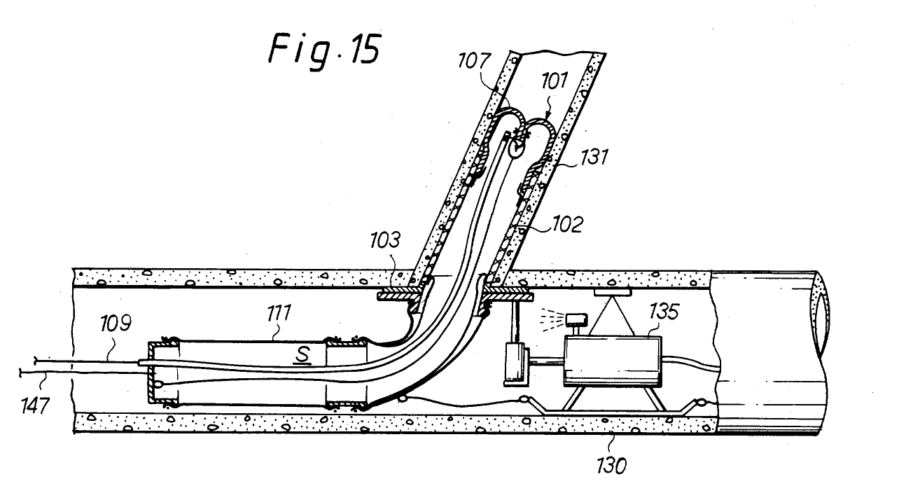

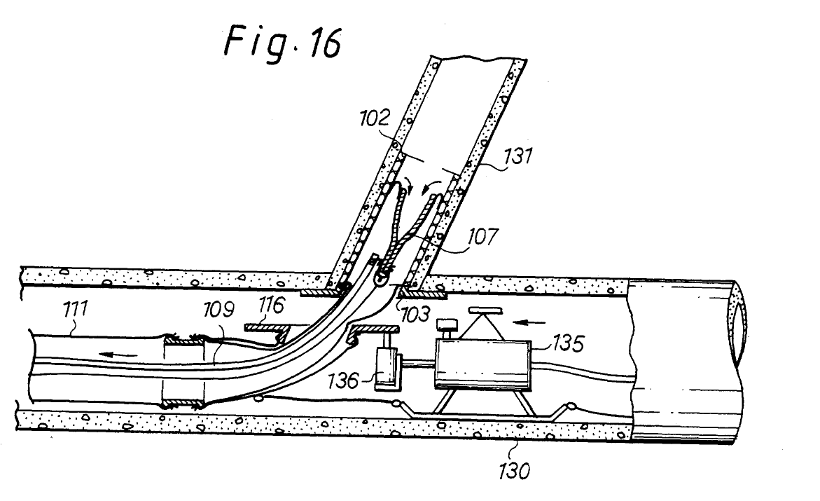

In the following, the method of lining the branch pipe according to one embodiment of the present invention will be described with reference to FIGS. 9 to 13. FIGS. 9-13 are cross-sectional views illustrating in order various steps of the method of lining the branch pipe.

As illustrated in FIG. 9, prior to the lining of the branch pipe 31, a work robot 35, previously assembled on the ground, the pressure bag 11, the branch pipe liner bag 1 and so on have been introduced into the main pipe 30 for the operation and set ready for the pipe lining operation.

The head collar 16, forming part of the pressure bag 11, is attached to the head 36 disposed at the leading end of the work robot 35. The flange 3 of the branch pipe liner bag 1 is carried on the head collar 16, and the remaining portion of the branch pipe liner bag 1 except for the flange 3 is contained in the pressure bag 11, as described above. A pull rope 43 is attached to the end collar 15 of the pressure bag 11, and the in-pipe work robot 35 is connected to the intermediate collar 14 of the pressure bag 11 by a rope 44. A TV camera 45 is mounted over the intermediate collar 14, and a TV cable 46 extending from the TV camera 45 is routed to the ground and connected to a monitoring device, not shown.

The pull rope 8 connected to the tear-off end 7 of the branch pipe liner bag 1 contained in the pressure bag 11 extends through the sealing construction 20 of the end collar 15 in an air-tight state to the outside of the pressure bag 11. The leading end of the pull rope 8 reaches the ground.

A closed space S defined by the end collar 15 and branch pipe liner bag 1 is formed within the pressure bag 11. The air hose 47 connected to the air hose attachment port 19 (see FIG. 4) formed through the end collar 15 is connected to a compressor, not shown, installed on the ground. Likewise, the hot water hoses 33, 34 respectively connected to the hot water supply port 17 and hot water discharge port 18 (see FIG. 3) of the end collar 15 are connected to a hot water supply facility, not shown, installed on the ground.

With the construction described above, the pull rope 39 or 43 is pulled to integrally move the work robot 35, the branch pipe liner bag 1 supported thereby, the pressure bag 11 and so on within the main pipe 30. While the situation within the main pipe 30 is being monitored on the TV monitor unit, not shown, installed on the ground through the TV cameras 40, 45, the flange 3 of the branch pipe liner bag 1 is positioned at an opening of the branch pipe 31, as illustrated in FIG. 9. Then, the head 36 of the work robot 35 is moved upward to press the flange 3 of the branch pipe liner bag 1 and the adhesive impregnated resin-adsorbent material 5 attached to the surface thereof onto the peripheral wall of a branch pipe opening 31a of the main pipe 30, thus bringing the adhesive impregnated resin-adsorbent material 5 into close contact with the peripheral edge of the branch pipe opening 31a. In this event, air has been exhausted from the closed space S defined within the pressure bag 11.

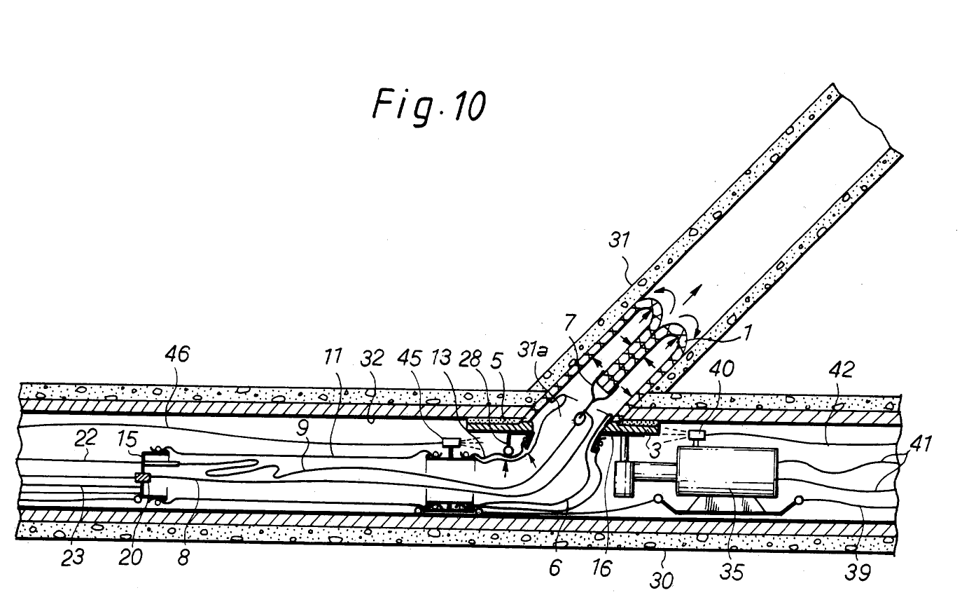

Next, as a compressor, not shown, installed on the ground is driven to supply the closed space S within the pressure bag 11 with compressed air through the air hose 47, the branch pipe liner bag 1, which is receiving the pressure of the compressed air, is everted and gradually inserted into the branch pipe 31 from the main pipe 30 to the ground (upward), as illustrated in FIG. 10. In this event, since the elbow bag 13 of the pressure bag 11 is inflated by the action of the pressure of the compressed air to push up the head collar push-up lever 28, the entire head collar 16 is pushed up to press the flange 3 of the branch pipe liner bag 1 and the adhesive impregnated resin-adsorbent material 5 onto the peripheral edge of the branch pipe opening 31a, thereby bringing the adhesive impregnated resin-adsorbent material 5 into close contact with the peripheral edge of the branch pipe opening 31a of the main pipe liner bag 32.

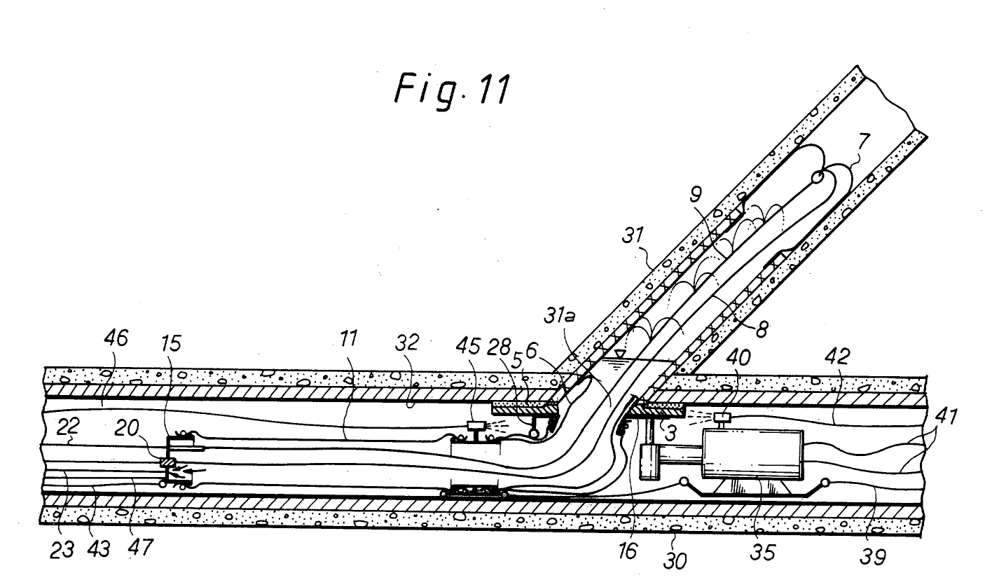

Here, the length of the branch pipe liner bag 1 is set shorter than the length of the branch pipe 31. When the branch pipe liner bag 1 has been fully everted into the branch pipe 31 as illustrated in FIG. 11, the branch pipe liner bag 1 is partially pressed onto the inner wall of a portion of the branch pipe 31 (over a predetermined length from the main pipe 30). In this event, the tear-off end 7 is everted as illustrated, so that the hot water hose 9 connected thereto is placed within the branch pipe liner bag 1, and the pull rope 8 is drawn into the closed space S through the sealing construction 20 of the end collar 15 in an air-tight state. In this event, high sealability is ensured in the closed space S by a sealing action of the sealing construction 20 and tear-off valve 6.

Then, a hot water pump and a boiler in the hot water facility, not shown, installed on the ground are driven to supply hot water to the hot water hoses 22, 9 while the inner pressure of the closed space S is held substantially constant in the aforementioned state. As illustrated in FIG. 11, the hot water is blown off from a plurality of nozzles, not shown, like a shower, to heat the branch pipe liner bag 1 from the inner side. The hot water, which has been used to heat the branch pipe liner bag 1 and cooled down, drops and stays on the bottom of the closed space S. The staying hot water is push out by the inner pressure of the closed space S to the hot water hose 23, returned to the hot water supply facility through the hot water hose 23, heated again by the boiler to a predetermined temperature, and supplied to the closed space S through the hot water hoses 22, 9 for heating the branch pipe liner bag 1.

By repeatedly circulating the hot water through the closed space S and hot water supply facility, the branch pipe liner bag 1 is heated by the hot water, and the thermosetting resin impregnated in the branch pipe liner bag 1 is hardened by heat transferred from the hot water. The inner wall of the branch pipe 31 is partially lined and repaired by the hardened branch pipe liner bag 1. Since the adhesive impregnated resin-adsorbent material 5 impregnated with an adhesive such as epoxy resin is attached to the surface of the flange 3 of the branch pipe liner bag 1, the flange 3 of the branch pipe liner bag 1 is securely adhered to the peripheral edge of the branch pipe opening 31a (from which the plastic film 33 was scraped off) of the main pipe liner bag 32 by an adhering action of the adhesive impregnated resin-adsorbent material 5.

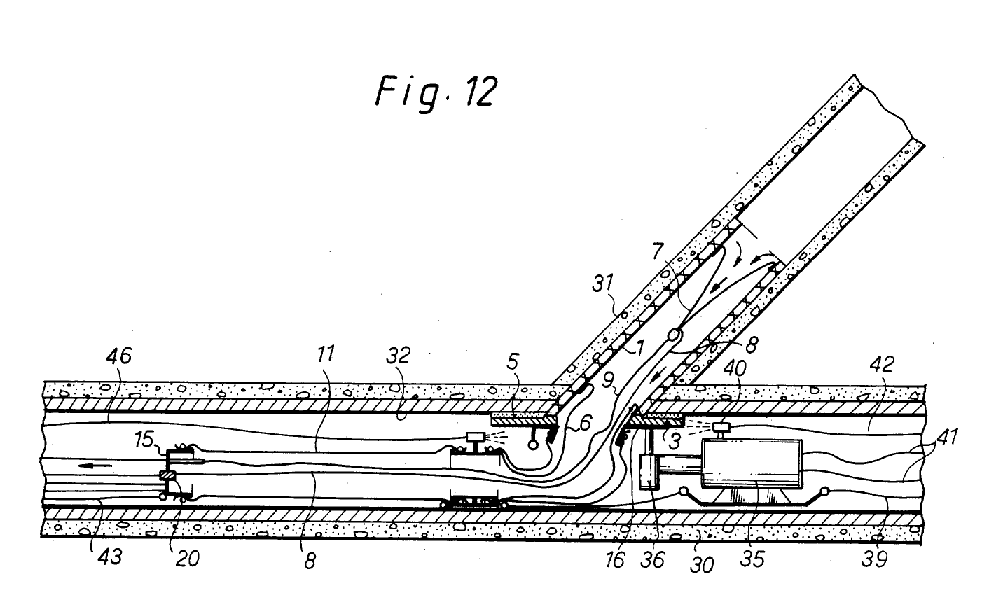

When the branch pipe liner bag 1 is hardened as described above, the hot water is removed from the closed space S. Then, as illustrated in FIG. 12, the pull rope 8 is pulled in a direction indicated by an arrow in FIG. 12, so that the tear-off end 7 is pulled by the pull rope 8 in the same direction, and separated from the inner surface of the branch pipe liner bag 1.

Subsequently, the head 36 of the work robot 35 is moved down to separate the head collar 16 from the flange 3 of the branch pipe liner bag 1, and the pull rope 49 or 43 is pulled to move the work robot 35, pressure bag 11, and the like within the main pipe 30 to tear off the tear-off valve 6 from the inner surface of the branch pipe liner bag 1. As the work robot 35 and pressure bag 11 are removed from the main pipe 30, the flange 3 of the hardened branch pipe liner bag 1 and the tubular resin-adsorbent material 2 are let in the branch pipe 31, thus completing a sequence of lining operations for the branch pipe 31.

As appreciated from the foregoing, in the method of lining a branch pipe according to the embodiment, the pull rope 8 is pulled to tear off the tear-off end 7 for removal from the branch pipe liner bag 1 after the branch pipe liner bag 1 has been hardened, so that no tension acts on the hot water hose 9. Consequently, a light-weighted hot water hose 9 can be used for the lining operation. Therefore, irrespective of the length of the hot water hose 9, the hot water hose 9 can be pulled with a force produced by everting the branch pipe liner bag 1 and placed inside of the branch pipe liner bag 1 without fail. It is therefore possible to stably line the branch pipe as required without fail.

In the foregoing embodiment, air pressure is used as a fluid pressure for use in everting the branch pipe liner bag 1 into the branch pipe 31. Alternatively, another fluid pressure may be used instead such as a water pressure. Also, while hot water is used as a heat medium for heating the branch pipe liner bag 1, steam, hot air, or the like may be used as the heat medium.

As is apparent from the foregoing description, according to the illustrated method of lining a branch pipe using the pressure bag, the pull rope is pulled to tear off the tear-off end for removal from the branch pipe liner bag after the branch pipe liner bag has been hardened, so that no tension acts on the heat medium hose. Consequently, a light-weighted heat medium hose can be used for the lining operation. Therefore, irrespective of the length of the heat medium hose, the heat medium hose can be pulled with a force produced by everting the branch pipe liner bag and placed inside of the branch pipe liner bag without fail. It is therefore possible to stably line the branch pipe as required without fail.

In addition, since the pressure bag is inflated by the action of the pressure of a fluid pressure to push up the head collar push-up lever, the entire head collar is pushed up to uniformly press the flange of the branch pipe liner bag onto the peripheral edge of the branch pipe opening, thereby bringing the flange into close contact with the peripheral edge of the branch pipe opening.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the pressure bag and the installation method has been described in the context of particularly preferred embodiments, the skilled artisan will appreciate, in view of the present disclosure, that certain advantages, features and aspects of the pressure bag or the installation method may be realized in a variety of other applications, such as, for example, to line a section of pipe other than a branch section. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims that follow.

What is claimed is:

1. A pressure bag for use in lining a branch pipe with a branch pipe liner bag, comprising:
an end collar which closes one end of said pressure bag for containing the branch pipe liner bag;
a heat medium supply port and a heat medium discharge port formed through said end collar; and
a sealing member for slidably supporting a pull rope or a belt extending therethrough in an air-tight state.

2. A pressure bag according to claim 1, further comprising:
a head collar including a head collar push-up lever movable associated with a fluid pressure acting on said pressure bag, said head collar attached to the other end of said pressure bag opposite to the end to which said end collar is attached.

3. A method of lining a branch pipe using a branch pipe liner bag having a tubular resin-absorbent material having a flange formed at one end thereof, the outer surface of said tubular resin-absorbent material being covered with a highly air-tight film, said tubular resin-absorbent material being impregnated with an unhardened hardenable resin, and a tear-off end attached to the other end of said tubular resin-adsorbent material, said method comprising:
introducing said branch pipe liner bag contained in a pressure bag except for said flange into a main pipe, said pressure bag comprising an end collar which closes one end of said pressure bag for containing the branch pipe liner bag, a heat medium supply port and a heat medium discharge port formed through said end collar, and a sealing member for slidably supporting a pull rope or a belt extending therethrough in an air-tight state;
placing said flange of said branch pipe liner bag in close contact with a peripheral edge of a branch pipe opening of the main pipe;
supplying a pressure fluid into said pressure bag to evert said branch pipe liner bag into the branch pipe from the main pipe to the ground by the action of a fluid pressure;
pulling a heat medium hose into a closed space defined by said pressure bag and said branch pipe liner bag;
supplying a heat medium from said heat medium hose into said closed space to heat said branch pipe liner bag with the heat medium;
hardening the thermosetting resin impregnated in said branch pipe liner bag; and
pulling said pull rope or belt to tear off said tear-off end for removal from the branch pipe.

4. A method of lining a branch pipe according to claim 3, further comprising:
lining the main pipe using a main pipe liner bag;
cutting a portion of said main pipe liner bag corresponding to the branch pipe opening; and
scraping off a coating plastic film of the main pipe liner bag around the peripheral edge of said branch pipe opening with a wire brush before lining the branch pipe.

5. A method of lining a branch pipe according to claim 3, wherein said pressure bag further includes a head collar including a head collar push-up lever, said head collar attached to the end of said pressure bag opposite to the end to which said end collar is attached, said method further comprising the step of applying the fluid pressure acting in said pressure bag to said head collar push-up lever to push up said head collar to press said flange of said branch pipe liner bag onto the peripheral edge of the branch pipe opening of said main pipe liner bag.

6. A lining device for use in a pipe lining comprising a tubular member having first and second end portions, a pipe liner bag adapted to be enclosed within the tubular member, one end of the pipe liner bag capable to be placed at an opening of the pipe through the first end portion, a removal member attached at another end of the pipe liner bag, a pulling member affixed to the removal member, the second end portion defining first and second ports, first port allowing a fluid to be drawn into the tubular member to pressurize the pipe liner bag, the second port allowing the pulling member to extend out of the tubular member, and a heat medium supplying member extending into the tubular member, an end of the heat medium supplying member affixed to the removal member, the pipe liner bag capable to extend into a pipe with carrying the pulling member and the heat medium supplying member by the removal member, the removal member being separable from the pipe liner bag with the heat medium supplying member when the pulling member is pulled.

7. The lining device according to claim 6, wherein the second port has a sealing construction slidably passing the pulling member.

8. The lining device according to claim 7, wherein the sealing construction comprises first and second sealing sections spaced apart from each other.

9. The lining device according to claim 7, wherein the sealing construction comprises at least one sealing member defining an opening, the pulling member extends through the opening, an inner diameter of the sealing member is smaller than an outer diameter of the pulling member such that the sealing member sealingly abuts the pulling member.

10. The lining device according to claim 9, wherein the sealing construction has a plurality of the sealing members.

11. The lining device according to claim 6, wherein the second portion additionally defining a third port, the heat medium supplying member comprises first and second sections, the first section extends out of the tubular member and is coupled with the third port, the second section extends within the tubular member and is coupled with the removal member.

12. The lining device according to claim 6, wherein the heat medium supplying member defining at least one opening through which a heat medium is supplied, the opening is formed close to the removal member.

13. The lining device according to claim 6, wherein the heat medium is hot water.

14. The lining device according to claim 6, wherein the fluid is air.

15. A method of lining a pipe comprising enclosing a pipe liner bag in a tubular member having first and second end portions, placing one end of the pipe liner bag at an opening of the pipe through the first end portion, attaching a removal member at another end of the pipe liner bag, affixing a pulling member to the removal member, extending the pulling member out of the tubular member through the second end portion, affixing a heat medium supplying member to the removal member, extending the heat medium supplying member out of the tubular member through the second end portion, supplying a pressurized fluid into the tubular member such that the pipe liner bag extends into the pipe with carrying the pulling member and the heat medium supplying member by the removal member, supplying a heat medium toward the pipe liner bag through the heat medium supplying member to heat the pipe liner bag, and pulling the pulling member to remove the removal member with the heat medium supplying member from the pipe liner bag.

16. The method according to claim 15, wherein the fluid is air.

17. The method according to claim 15, wherein the heat medium is hot water.
